(19) United States
(12) Patent Application Publication
(10) Pub. No.: US 2021/0382828 A1
(43) Pub. Date: Dec. 9, 2021

(54) METHOD AND SYSTEM FOR FACILITATING ACCELERATION OF A MAPPING TABLE RECONSTRUCTION

(71) Applicant: Alibaba Group Holding Limited, Grand Cayman (KY)

(72) Inventor: Shu Li, Bothell, WA (US)

(73) Assignee: Alibaba Group Holding Limited, Grand Cayman (KY)

(21) Appl. No.: 16/891,778

(22) Filed: Jun. 3, 2020

(51) Int. Cl. G06F 12/1009

(52) U.S. Cl. CPC G06F 12/1009; G06F 2212/1032

(57) ABSTRACT

One embodiment provides a system which facilitates reconstruction of a mapping table. During operation, the system writes at a first physical block address, first data and a corresponding first logical block address to a block of a non-volatile memory. The system stores, in a mapping table, an entry which maps the first logical block address to the first physical block address. The system writes the first logical block address to a journal in a spare page of the block, wherein the journal indicates logical block addresses in an order corresponding to physical block addresses of data written to the block. The system rebuilds the mapping table by: reading the journal to obtain the logical block addresses; and determining, based on the order, the physical block addresses corresponding to the obtained logical block addresses.

### BACKGROUND

### Field

This disclosure is generally related to the field of data storage. More specifically, this disclosure is related to a method and system for facilitating acceleration of a mapping table reconstruction.

### Related Art

Today, various storage systems are being used to store and access the ever-increasing amount of digital content. A storage system can include various storage devices which can provide persistent memory, e.g., a solid state drive (SSD) and a hard disk drive (HDD). One type of SSD is an Open-Channel SSD, in which a host operates the flash translation layer (FTL). A host-side FTL can provide a host with transparency and flexibility in directly managing the physical addresses, and can also improve the efficiency of the storage stack with fewer barriers. For example, the host-side FTL can maintain a “mapping table” which stores a mapping of logical block addresses to physical block addresses. However, in a host-side FTL, any crash or failure of the host can immediately affect the SSD. An application obtaining service from a host-side FTL and an SSD may require a fast failover, i.e., re-starting the service and providing host-side FTL services within a certain period of time.

Recovering from a failure and restarting services can include rebuilding or reconstructing the mapping table. In a conventional system, data is written with its corresponding LBA to the non-volatile memory, e.g., NAND, at an assigned PBA, while the LBA to PBA mapping table is stored in DRAM. In order to rebuild the mapping table, the conventional system must out all valid pages of data along with their corresponding LBAs from known PBAs in the NAND. The conventional system can rebuild the mapping based on the known LBA to PBA relationships. However, this read process may involve a non-trivial read amplification, as the system must read out each page of data along with its LBA in order to determine the corresponding PBA. For example, the system may read a 4 KB sector of data in order to obtain the 4B LBA, while discarding the remainder of the read data. This read amplification can result in a long recovery wait time, which can delay the system from providing host-side FTL services, including execution of read and write operations.

These challenges (including the read amplification incurred by a conventional system in rebuilding the mapping table) can result in a decrease in the overall efficiency, lifespan, and performance of a storage system.

### SUMMARY

One embodiment provides a system which facilitates reconstruction of a mapping table. During operation, the system writes at a first physical block address, first data and a corresponding first logical block address to a block of a non-volatile memory. The system stores, in a mapping table, an entry which maps the first logical block address to the first physical block address. The system writes the first logical block address to a journal in a spare page of the block, wherein the journal indicates logical block addresses in an order corresponding to physical block addresses of data written to the block.

In some embodiments, the system receives requests to write the first data and other data to the non-volatile memory, wherein the requests indicate the logical block addresses. The system writes, at a respective physical block address, respective data and a respective logical block address to the block of the non-volatile memory. The system writes the logical block addresses to the journal in the spare page or another spare page of the block.

In some embodiments, the system writes the logical block addresses in the journal responsive to determining that a buffer storing the logical block addresses stores an amount of data sufficient to fill the spare page of the block.

In some embodiments, the first logical block address is written to the journal in the spare page of the block in parallel with the first data and the first logical block address being written to the block.

In some embodiments, the system interleaves the write of the data and the write of the logical block addresses in the journal, wherein the first logical block address is written to the journal in the spare page of the block subsequent to the first data and the first logical block address and at least the respective data and the respective logical block address being written to the block.

In some embodiments, the system detects a condition which triggers the rebuilding of the mapping table. The system rebuilds the mapping table by: reading the journal to obtain the logical block addresses; and determining, based on the order, the physical block addresses corresponding to the obtained logical block addresses.

In some embodiments, the system rebuilds the mapping table by the following operations. The system reads journals from each of a plurality of blocks of the non-volatile memory to obtain a consolidated list of LBAs, wherein a respective journal indicates logical block addresses (LBAs) ordered corresponding to physical block addresses (PBAs) of data written to a respective block. The system identifies, from the consolidated list for each unique logical block address, a most recent logical block address (LBA) and the corresponding physical block address (PBA) to obtain unique LBA-PBA pairs. The system sorts the unique LBA-PBA pairs in an ascending order based on the LBA to obtain the mapping table.

In some embodiments, the mapping table is used by a flash translation layer module to perform subsequent read and write operations associated with the non-volatile memory.

In some embodiments, the first physical block address is assigned by a flash translation layer module.

In some embodiments, the above described operations can be performed as a method. In other embodiments, the system can include an apparatus configured to perform these methods.

### BRIEF DESCRIPTION OF THE FIGURES

FIG. 1A illustrates an architecture of an exemplary distributed storage system, in accordance with the prior art.

FIG. 1B illustrates an exemplary organization of data stored with its corresponding LBA, in accordance with the prior art.

FIG. 2A illustrates an exemplary environment 200 for programming a NAND block, in accordance with the prior art.

FIG. 2B illustrates an exemplary environment with an LBA journal which facilitates acceleration of a mapping table reconstruction, in accordance with an embodiment of the present application.

FIG. 3 illustrates an exemplary environment for programming a NAND block using the LBA journal, in accordance with an embodiment of the present application.

FIG. 4 illustrates an exemplary environment for writing the LBA journal in parallel with data pages in an open super block, in accordance with an embodiment of the present application.

FIG. 5A illustrates an exemplary environment for writing the LBA journal and the data pages, without interleaving, in accordance with an embodiment of the present application.

FIG. 5B illustrates an exemplary environment for interleaving the writing of the LBA journal and the data pages, in accordance with an embodiment of the present application.

FIG. 6 illustrates an exemplary environment for rebuilding a mapping table, including consolidating and sorting read LBA journals, in accordance with an embodiment of the present application.

FIG. 7A presents a flowchart illustrating a method for facilitating reconstruction of a mapping table, in accordance with an embodiment of the present application.

FIG. 7B presents a flowchart illustrating a method for facilitating reconstruction of a mapping table, in accordance with an embodiment of the present application.

FIG. 7C presents a flowchart illustrating a method for facilitating reconstruction of a mapping table, in accordance with an embodiment of the present application.

FIG. 8 illustrates an exemplary computer system that facilitates reconstruction of a mapping table, in accordance with an embodiment of the present application.

FIG. 9 illustrates an exemplary apparatus that facilitates reconstruction of a mapping table, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein facilitate an accelerated reconstruction of a mapping table in an SSD with a host-side FTL (e.g., an Open Channel SSD).

As described above, a host-side FTL can provide transparency and flexibility in directly managing the physical addresses, and can maintain a mapping table which stores a mapping of logical block addresses (LBAs) to physical block addresses (PB As). However, any crash or failure of the host may immediately affect the SSD. An application obtaining service from a host-side FTL and an SSD may require a fast failover, i.e., re-starting the service and providing host-side FTL services within a certain period of time.

Recovering from a failure and restarting services can include rebuilding or reconstructing the mapping table. In a conventional system, data is written with its corresponding LBA to the non-volatile memory, e.g., NAND, at an assigned PBA, while the LBA to PBA mapping table is stored in DRAM. In order to rebuild the mapping table, the conventional system must out all valid pages of data along with their corresponding LBAs from known PBAs in the NAND. The conventional system can rebuild the mapping based on the known LBA to PBA relationships. However, this read process may involve a non-trivial read amplification, as the system must read out each page of data along with its LBA in order to determine the corresponding PBA. For example, the system may read a 4 KB sector of data in order to obtain the 4B LBA, while discarding the remainder of the read data. This read amplification can result in a long recovery wait time, which can delay the system from providing host-side FTL services, including execution of read and write operations. These challenges (including the read amplification incurred by a conventional system in rebuilding the mapping table) can result in a decrease in the overall efficiency, lifespan, and performance of a storage system.

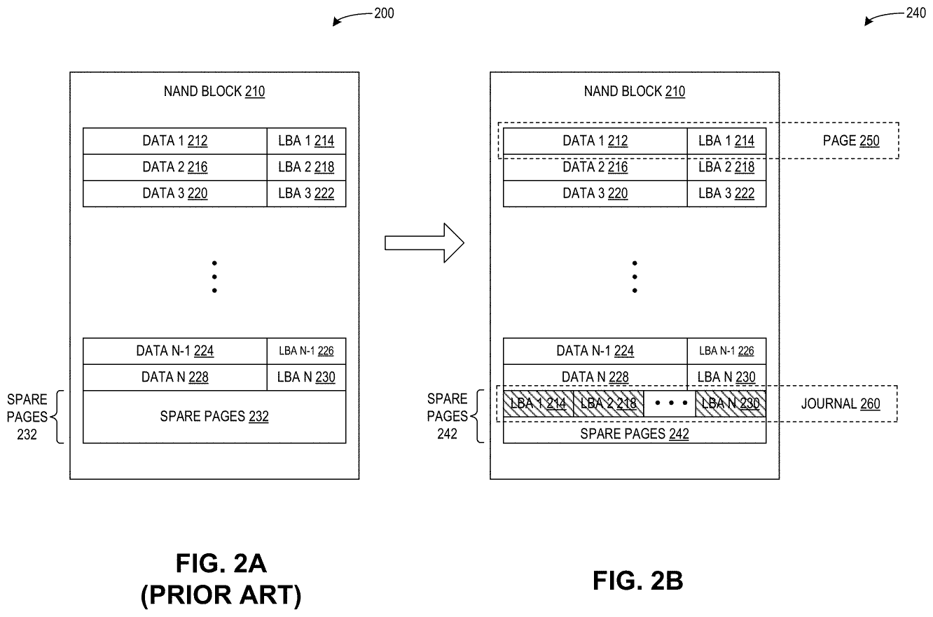

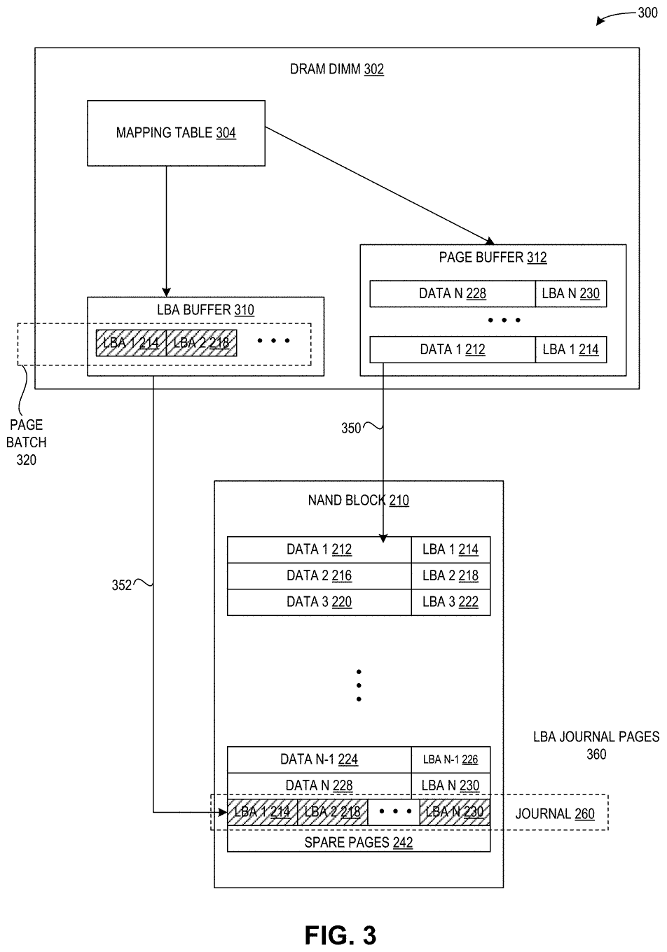

The embodiments described herein address these challenges by providing a system with an additional layer of protection, i.e., in addition to storing data with its corresponding LBA in a respective physical page. The system provides the additional layer by utilizing the spare pages of a NAND block and storing the LBAs of data written to the NAND block in a separate journal in a spare page of the same NAND block. Because the programming order or sequence of a NAND block is determined or known, the system can use the sequence of LBAs written in the journal to reconstruct the mapping of LBAs to PBAs in the same NAND block. An exemplary environment for accelerating the mapping table reconstruction is described below in relation to FIGS. 2 and 3.

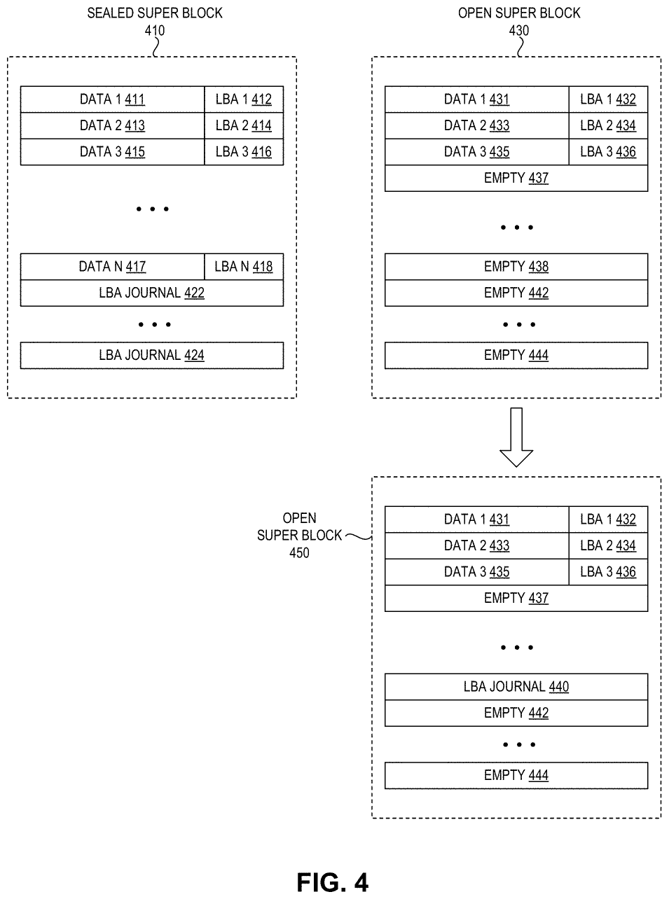

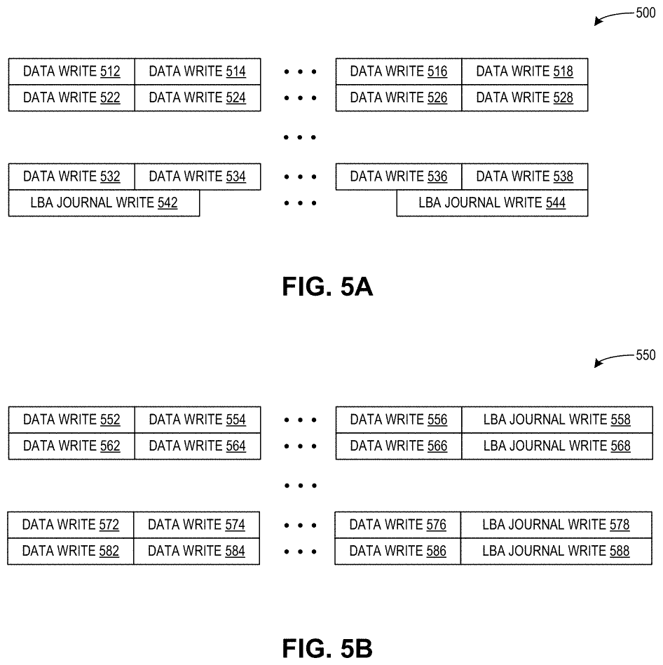

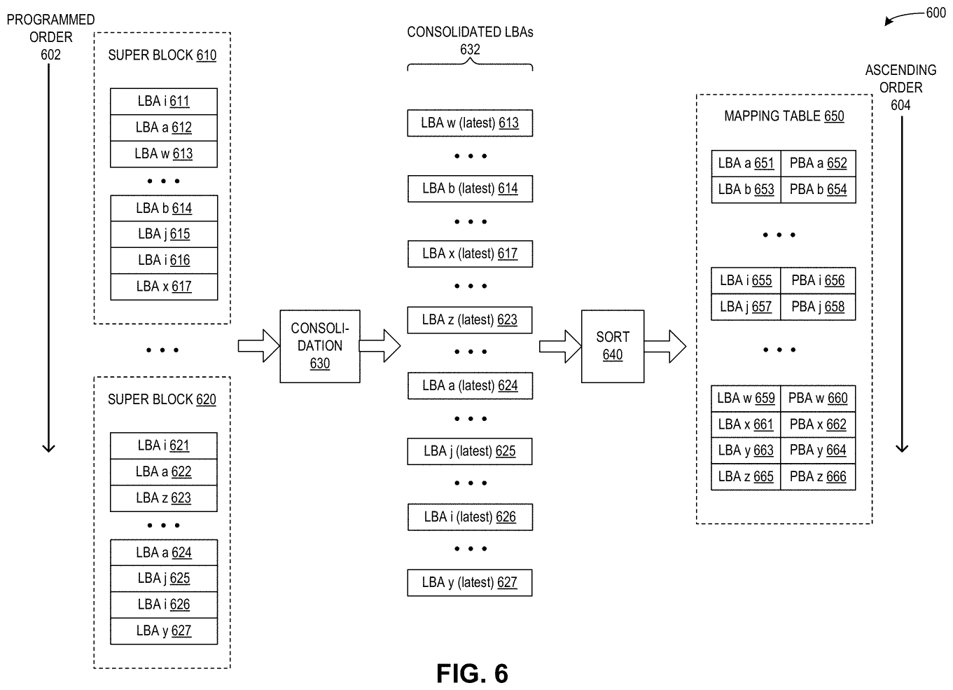

Furthermore, the system can write the LBAs in the journal in parallel with the data pages, and can treat an open super block in the same manner as a sealed super block, which can increase the efficiency and optimize the performance of the overall storage system, as described below in relation to FIG. 4. The system can also interleave the writing of the data pages and the journal LBAs, which can mitigate both the burden of flushing the LBA journal and the requirement for power loss protection. An exemplary interleaving is described below in relation to FIG. 5. The system can also reconstruct the mapping table by taking into account only the most recent version of LBAs with their corresponding LBAs, as described below in relation to FIG. 6.

Thus, the system provides an additional layer for the LBA to PBA mapping table reconstruction, by writing LBAs (corresponding to data written in a given block) to a journal in a spare page of the given block. This additional layer can result in a decreased read amplification, which in turn can result in improvements in the efficiency, lifespan, and performance of a storage system.

A “storage system infrastructure,” “storage infrastructure,” or “storage system” refers to the overall set of hardware and software components used to facilitate storage for a system. A storage system can include multiple clusters of storage servers and other servers. A “storage server” refers to a computing device which can include multiple storage devices or storage drives. A “storage device” or a “storage drive” refers to a device or a drive with a non-volatile memory which can provide persistent storage of data, e.g., a solid state drive (SSD), a hard disk drive (HDD), or a flash-based storage device.

A “computing device” refers to any server, device, node, entity, drive, or any other entity which can provide any computing capabilities.

A “journal” or “LBA journal” refers to a group or list of LBAs which are written to a spare page in a block, where the LBAs included in the journal or LBA journal are in an order which corresponds to physical block addresses of data written to the block.

A “mapping table” table refers to a table which stores a mapping of logical addresses (such as logical block addresses) to physical addresses (such as physical block addresses). The terms “reconstructing” and “rebuilding” the mapping table are used interchangeably, and refer to a process or operation which occurs in a system when recovering from a failure and restarting services, as described herein.

### Architecture of Exemplary System in the Prior Art

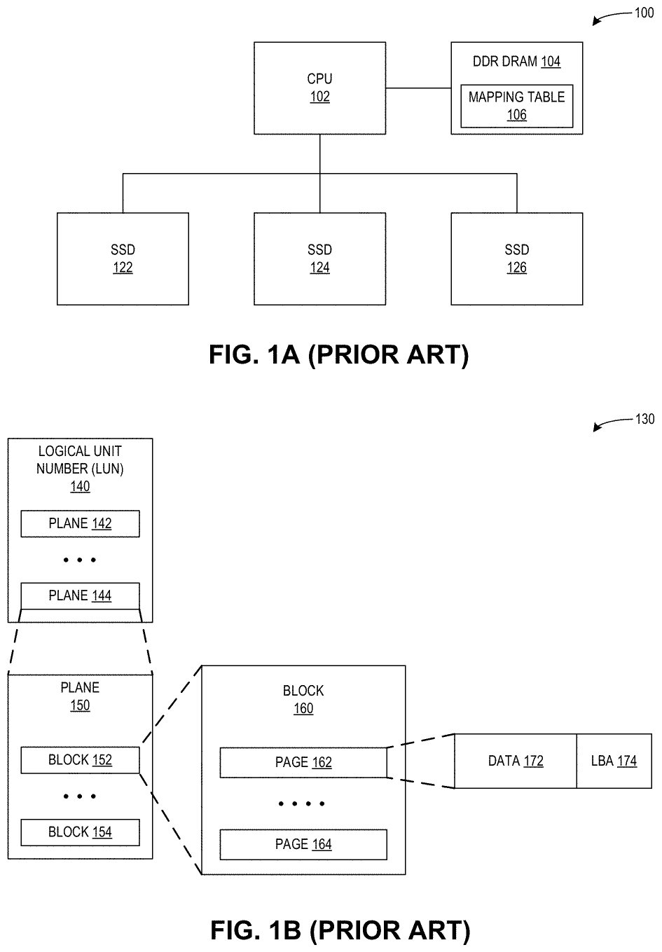

FIG. 1A illustrates an architecture of an exemplary distributed storage system 100, in accordance with the prior art. Distributed storage system 100 can include: a CPU 102; an associated DDR DRAM 104, which can store a mapping table 106; and SSDs 122, 124, and 126. System 100 can maintain mapping table 106 in DRAM 104 for low-latency access. The system can build the mapping table by writing the data together with its corresponding LBA to the NAND while programming the NAND flash. If the system needs to rebuild mapping table 106, the system must read all pages of the programmed data along with the correspondingly stored LBAs. For each page, based on the sequential order of programming, the system knows the physical block addresses associated with a given page, and, upon reading out the LBAs for the given page, the system can create a correspondence, association, or mapping between a PBA and an LBA. The system can read out all pages stored in NAND, and can rebuild the mapping table in this manner.

However, reading out all the pages of valid data from the NAND can result in a high latency. In addition, the read amplification can be non-trivial. For example, the system must read a 4 KB data sector in order to retrieve the corresponding 4 B LBA while discarding the remainder of the data sector.

FIG. 1B illustrates an exemplary organization 130 of data stored with its corresponding LBA, in accordance with the prior art. In general, a high-capacity SSD can be associated with many logical unit numbers (LUNs), which each identify a logical unit. In a distributed storage system, organization 130 can depict data stored in a plurality of logical units, which can each be identified by a logical unit number (LUN), such as a LUN 140. Each LUN can store data in a plurality of planes, such as planes 142 and 144. Each plane can store data in a plurality of blocks, such as blocks 152 and 154. Each block can store data in a plurality of pages, such as pages 162 and 164. Page 162 can store data 172 along with its corresponding LBA 174.

The many LUNs may include hundreds of NAND blocks, resulting in a significant or large amount of data being read and transferred during reconstruction or rebuilding of a mapping table. This time-consuming and resource-consuming reconstruction process may result in a longer period of time required before the system can recover and provide services related to read/write operations. This can result in a decreased efficiency in the performance of the overall distributed storage system.

### Exemplary LBA Journal; Exemplary Environment for Programming a NAND Block

FIG. 2A illustrates an exemplary environment 200 for programming a NAND block, in accordance with the prior art. Environment 200 can include a NAND block 210, where data is written as data sectors along with their corresponding LBAs, as depicted above in relation to FIG. 1B. For example, NAND block 210 can store: data 1 212 and a corresponding LBA 1 214; data 2 216 and a corresponding LBA 2 218; data 3 220 and a corresponding LBA 3 222; data N−1 224 and a corresponding LBA N−1 226; and data N 228 and a corresponding LBA N 230. NAND block 210 can also store spare pages 232. Each NAND block in a conventional storage system generally includes spare pages (e.g., spare pages 232), to be used for overprovisioning, data recovery, and other purposes.

FIG. 2B illustrates an exemplary environment 240 with an LBA journal 260 which facilitates acceleration of a mapping table reconstruction, in accordance with an embodiment of the present application. Environment 240 can include NAND block 210, which can store the same data 1-N 212-228 along with their corresponding LBAs 1-N 214-230, as described above in FIG. 2A. However, in the embodiment described in environment 240, NAND block 210 can use the spare pages in a different manner. The system can store journal 260 in one or more of spare pages 242 of NAND block 210. Journal 260 can include LBAs 1-N 214-230 (indicated as filled in with diagonally right-slanting lanes), stored in an order which corresponds to the order in which the corresponding data is programmed into NAND block 210. By storing the LBAs of a given block in a journal which is stored in a spare page(s) of the given block, the system can provide a layer of protection, which is in addition to storing data with its corresponding LBA in a respective physical page.

In some embodiments, environment 200 can reflect a state of NAND block 210 at a time t0, while environment 240 can reflect a state of NAND block 210 at a time t1, i.e., when a buffer which stores LBAs to be written to journal 260 includes an amount of data sufficient to fill a physical page of NAND block 210 (to fill one of spare pages 232 or 242 of NAND block 210).

FIG. 3 illustrates an exemplary environment 300 for programming a NAND block 210 using LBA journal 260, in accordance with an embodiment of the present application. Environment 300 can include a DRAM DIMM 302 and a NAND block 210. DRAM DIMM 302 can include: a mapping table 304, which can store LBA to PBA mappings; an LBA buffer 310; and a page buffer 312. LBA buffer 310 can store a group of LBAs which correspond to data stored in page buffer 312, which data and corresponding respective LBA is to be written to a given NAND block, such as NAND block 210. The system can determine that a page batch 320 stores a plurality of LBAs which include an amount of data sufficient to fill a physical page in a spare page(s) of a given block.

For example, DRAM DIMM 302 can receive the data to be stored, along with its corresponding LBA. An FTL module can run as an application on the host side which maintains the mapping table. The FTL module can determine or assign a PBA for the corresponding LBA, and the system can write the data and its LBA in page buffer 312, and can also write the LBA to LBA buffer 310. For example, the system can receive a data 1 212 with a corresponding LBA 1 214. The system can write data 1 212 and LBA 1 214 to page buffer 312, and can also write LBA 1 214 to LBA buffer 310.

When a page batch is complete, or when page buffer 312 is sufficient to fill one or more physical pages, or based on another condition, the system can write the data (i.e., data and LBAs) from page buffer 312 to NAND block 210 (via a communication 350), and the system can also write the data (i.e., LBAs) in page batch 320 from LBA buffer 310 to NAND block 210 (via a communication 352), as journal 260 in spare pages 242.

In the event of a DRAM failure, power loss, or other error, if the amount of data in page batch 320 is not sufficient to fill a physical page, the system can pad the content in page batch 320 of LBA buffer 310 with a fixed data pattern (e.g., dummy data or a dummy pattern) to form a full page, which can be written to a spare page of NAND 210.

Writing LBA Journal in Parallel with Data Pages; and Interleaving the Writing of the LBA Journal and the Data Pages

The described embodiments can also provide an improvement in an open super block for reconstruction of the mapping table, by writing the LBA journal in parallel or in an interleaved manner with the data pages. FIG. 4 illustrates an exemplary environment 400 for writing the LBA journal in parallel with data pages in an open super block, in accordance with an embodiment of the present application. Environment 400 can include a sealed super block 410 and open super blocks 430 and 450. Open super block 430 can indicate an open super block in the prior art, or can represent open super block 450 at an earlier time. That is, open super block 430 can depict what occurs without interleaving while open super block 450 can depict what occurs with interleaving. An example of interleaving is provided below in relation to FIGS. 5A and 5B.

Sealed super block 410 can include data 1 411 to N 417, with their corresponding LBAs 1 412 to N 418. Sealed super block 410 can also include LBA journals 422 and 424, written to spare pages (not indicated) of sealed super block 410. Open super block 430 can include data 1 431 to 3 435, with their corresponding LBAs 1 432 to 3 436. Open super block 430 can also include empty pages 438, 442, and 444. If the system writes the LBAs to an LBA journal only when all the data pages are filled, an open super block may not include an LBA journal, e.g., no LBA journal depicted in open super block 430. Without the LBA journal, the system will need to read out the actual data from open super block 320 (as described above in relation to the prior art environment of FIGS. 1A, 1B, and 2A). This can result in a read amplification, an increase in the amount of time involved to reconstruct the mapping table, and a decrease in the efficiency due any potential delays in recovery related to the reconstruction of the mapping table.

To address this issue, the embodiments of the system described herein can write the LBA journal in parallel with the data pages, or in an interleaved fashion. In open super block 450, the system can store data 1 431-3 345, along with their corresponding LBAs 1 432 to 3 436. The system can then write LBA journal 440 to open super block 450 (leaving the subsequent space in open super block 450 empty, e.g., empty page 437), even if the corresponding page buffer or LBA buffer for the super block is not currently storing an amount of data sufficient to fill a full physical (spare) page in the super block. Spare pages after LBA journal 440 can be indicated by empty pages 442 and 444.

By writing LBA journal 440 in an interleaved manner with data 1 431 to 3 345 and corresponding LBAs 1 432 to 3 436, the system can treat sealed super blocks and open super blocks in the same manner. The system does not need to read out any actual stored data (such a data and LBAs 431-436). Instead, because the data pages are physically programmed in a sequential order (based on the host-side assigned PBAs), the system need only read out the LBA journals from both sealed and open super blocks in order to quickly, efficiently, and simply reconstruct the mapping table.

Moreover, the system can determine that either a page batch of an LBA buffer (as in FIG. 3) is sufficiently full of data to fill a spare page in a NAND block (as an LBA journal), or that a condition has been met in order to write the page batch to a spare page in the NAND block. The condition can be based on one or more of, e.g.: an amount of time since the most recent LBA is written to the LBA buffer; a programmed time series; whether a predetermined time period or interval has passed or been reached; an amount of space available to be filled or already filled in a page batch or the LBA buffer as compared with a predetermined threshold or a predetermined ratio (i.e., of filled to unfilled/available space in the page batch or the LBA buffer); and an algorithm or rule configured by the system or the user.

For example, the system can interleave the data pages with the LBA journal writes based on a programmed time series. FIG. 5A illustrates an exemplary environment 500 for writing the LBA journal and the data pages, without interleaving, in accordance with an embodiment of the present application. In environment 500, the system can write data writes 512-538 to NAND, and subsequently write LBA journal writes 542 and 544 to spare pages of the NAND (either in a given block or a super block). Environment 500 can be associated with sealed super block 410 or open super block 430 of FIG. 4.

FIG. 5B illustrates an exemplary environment 550 for interleaving the writing of the LBA journal and the data pages, in accordance with an embodiment of the present application. In environment 500, the system can write a few data writes to the NAND, followed immediately by a corresponding LBA journal write to a spare page of the NAND. For example: the system can write the following: data writes 552-556, followed by an LBA journal write 558; data writes 562-566, followed by an LBA journal write 568; data writes 572-576, followed by an LBA journal write 578; and data writes 582-586, followed by an LBA journal write 588. By making the LBA journal information available for subsequent retrieval, this “interleaving” can eliminate the need for the system to read out any actual data in order to reconstruct the mapping table.

### Exemplary Environment for Rebuilding a Mapping Table

FIG. 6 illustrates an exemplary environment 600 for rebuilding a mapping table, including consolidating and sorting read LBA journals, in accordance with an embodiment of the present application. Environment 600 can include super blocks 610 and 620, which can each include data stored corresponding to depicted LBAs 611-617 and 621-627, respectively, as well as LBAs journals (not shown) which include these depicted LBAs. The data stored in super blocks 610 and 620 can be stored in a programmed order 602, and thus reading out the LBA journals can result in determining the corresponding PBA for a specific LBA listed or included in an LBA journal.

The system can read out the LBA journal(s) from each NAND block or super block. The system can concatenate the read results based on the originally programmed sequence. The system can consolidate this LBA journal concatenation, scan the LBA journal concatenation to identify the latest or most recent LBA for each unique LBA, and use this latest or most recent LBA and its corresponding PBA to obtain unique LBA-PBA pairs (via a consolidation module 630), resulting in consolidated LBAs 632.

Consolidated LBAs 632 can include all the LBAs from LBA journal concatenation, where the indicated LBAs are identified as the most recent version of data corresponding to a unique LBA, e.g., LBAs w 613, b 614, x 617, z 623, a 624, j 625, i 626, and y 627. The system can sort these identified most recent LBAs (which can be indicated as unique LBA-PBA pairs) (via a sort module 640), and store the sorted results in a mapping table 650.

Mapping table 650 indicates the reconstructed mapping table, where the LBA-PBA pairs are stored based on the respective LBA value in an ascending order 604, e.g.: LBA a 651 and PBA a 652; LBA b 653 and PBA b 654; LBA i 665 and PBA i 656; LBA j 657 and PBA j 658; LBA w 659 and PBA w 660; LBA x 661 and PBA x 662; LBA y 663 and PBA y 664; and LBA z 665 and PBA z 666.

### Method for Facilitating Operation of a Storage System

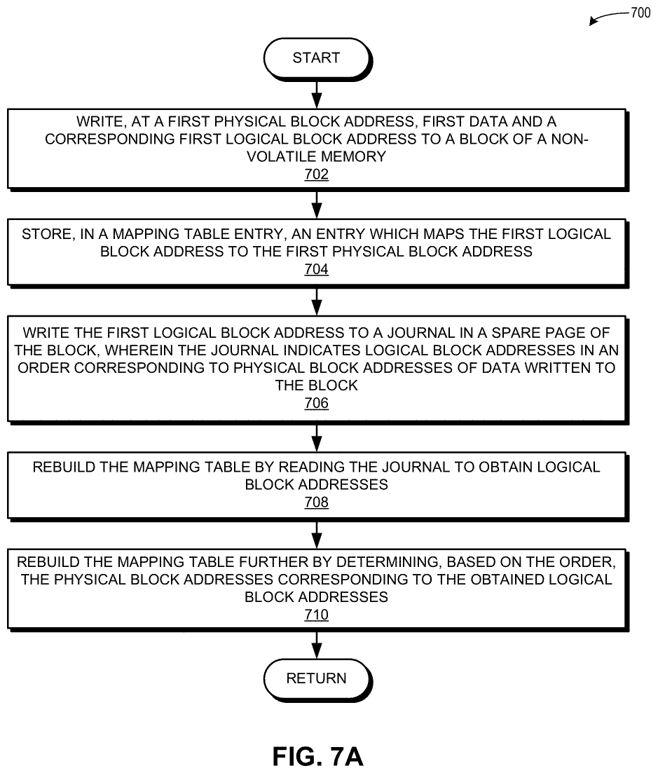

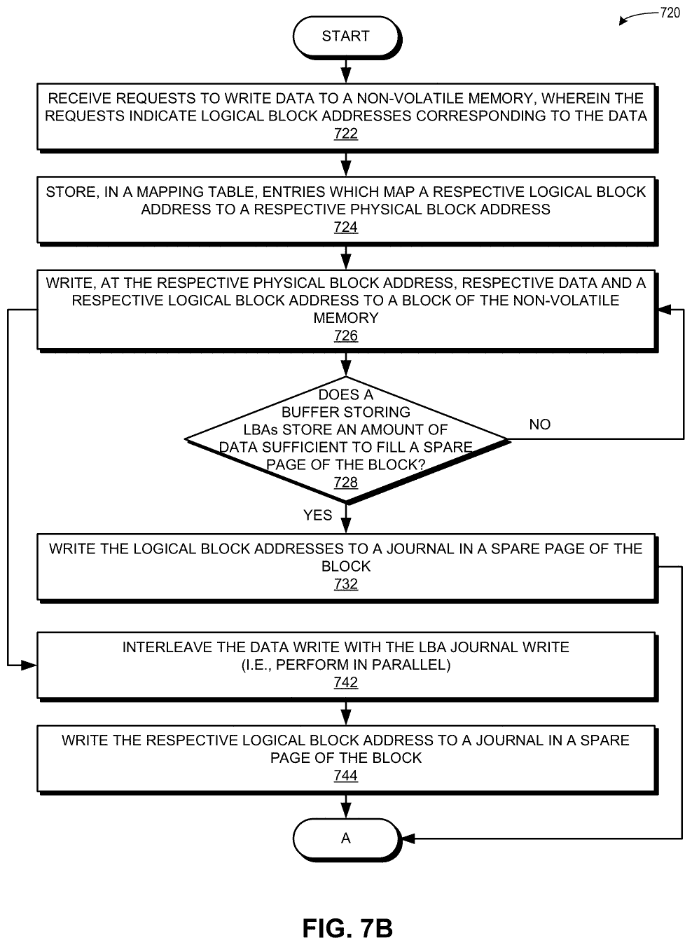

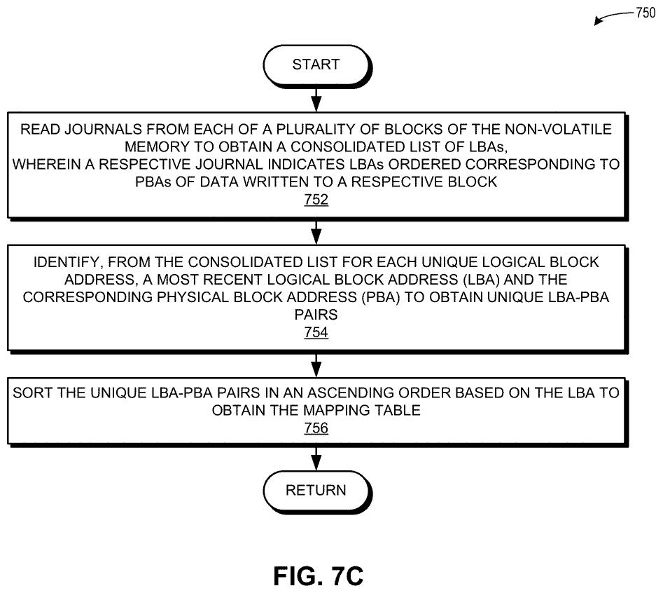

FIG. 7A presents a flowchart 700 illustrating a method for facilitating reconstruction of a mapping table, in accordance with an embodiment of the present application. During operation, the system writes, at a first physical block address, first data and a corresponding first logical block address to a block of a non-volatile memory (operation 702). The system stores, in a mapping table, an entry which maps the first logical block address to the first physical block address (operation 704). The system writes the first logical block address to a journal in a spare page of the block, wherein the journal indicates logical block addresses in an order corresponding to physical block addresses of data written to the block (operation 706). The system can detect a condition which triggers rebuilding of the mapping table (not shown). In response to the detected condition, the system rebuilds the mapping table by reading the journal to obtain the logical block addresses (operation 708), and further rebuilds the mapping table by determining, based on the order, the physical block addresses corresponding to the obtained logical block addresses (operation 710), and the operation returns.

FIG. 7B presents a flowchart illustrating a method 720 for facilitating reconstruction of a mapping table, in accordance with an embodiment of the present application. During operation, the system receives requests to write data to a non-volatile memory, wherein the requests indicate logical block addresses corresponding to the data (operation 722). The system stores, in a mapping table, entries which map a respective logical block address to a respective physical block address (operation 724). The system writes, at the respective physical block address, respective data and a respective logical block address to a block of the non-volatile memory (operation 726). If a buffer storing LBAs does not store an amount of data sufficient to fill a spare page of the block (decision 728), the operation continues operation 726 (or 722).

If a buffer storing LBAs does store an amount of data sufficient to fill a spare page of the block (decision 728), the system writes the logical block addresses to a journal in a spare page of the block (operation 732), and the operation continues at Label A of FIG. 7C.

Subsequent to the system writing the respective data and respective logical block address to the block, the system can also interleave the data write with the LBA journal write (i.e., performs these operations in parallel or based on a condition, as described above in relation to FIG. 5B) (operation 742). The system writes the respective logical block address to a journal in a spare page of the block (operation 744), and the operation continues at Label A of FIG. 7C.

FIG. 7C presents a flowchart 750 illustrating a method for facilitating reconstruction of a mapping table, in accordance with an embodiment of the present application. During operation, the system reads journals from each of a plurality of blocks of the non-volatile memory to obtain a consolidated list of

LBAs, wherein a respective journal indicates logical block addresses (LBAs) ordered corresponding to physical block addresses (PBAs) of data written to a respective block (operation 752). The system identifies, from the consolidated list for each unique logical block address, a most recent logical block address (LBA) and the corresponding physical block address (PBA) to obtain unique LBA-PBA pairs (operation 754). The system sorts the unique LBA-PBA pairs in an ascending order based on the LBA to obtain the mapping table (operation 756).

### Exemplary Computer System and Apparatus

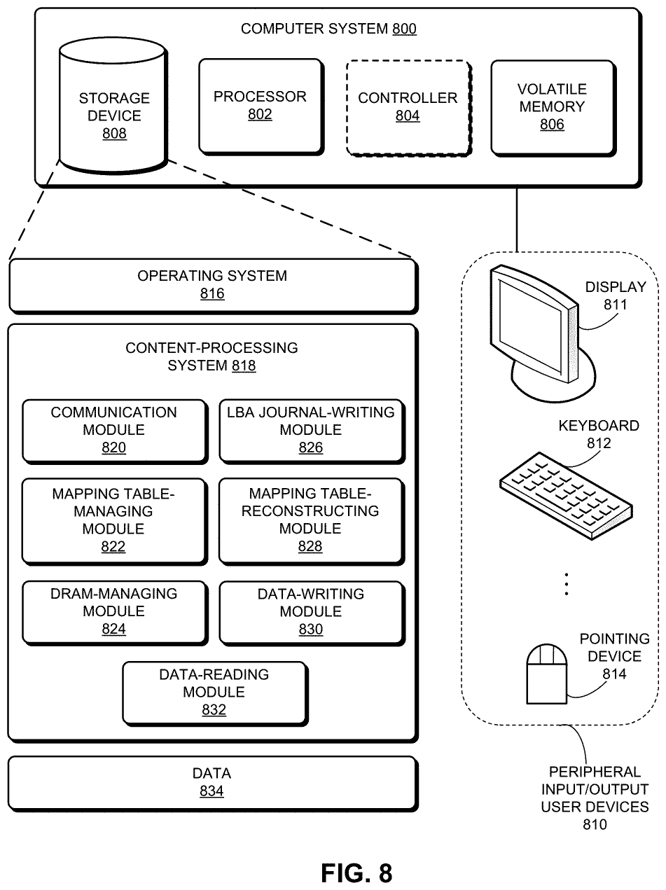

FIG. 8 illustrates an exemplary computer system that facilitates reconstruction of a mapping table, in accordance with an embodiment of the present application. Computer system 800 includes a processor 802, a volatile memory 806, and a storage device 808. In some embodiments, computer system 800 can include a controller 804 (indicated by the dashed lines). Volatile memory 806 can include, e.g., random access memory (RAM), that serves as a managed memory, and can be used to store one or more memory pools. Storage device 808 can include persistent storage which can be managed or accessed via processor 802 (or controller 804). Furthermore, computer system 800 can be coupled to peripheral input/output (I/O) user devices 810, e.g., a display device 811, a keyboard 812, and a pointing device 814. Storage device 808 can store an operating system 816, a content-processing system 818, and data 836.

Content-processing system 818 can include instructions, which when executed by computer system 800, can cause computer system 800 or processor 802 to perform methods and/or processes described in this disclosure. Specifically, content-processing system 818 can include instructions for receiving and transmitting data packets, including data to be read or written, an input/output (I/O) request (e.g., a read request or a write request), and a logical block address (LBA) (communication module 820).

Content-processing system 818 can further include instructions for writing, at a first physical block address, first data and a corresponding first logical block address to a block of a non-volatile memory (data-writing module 830). Content-processing system 818 can include instructions for storing, in a mapping table, an entry which maps the first logical block address to the first physical block address (mapping table-managing module 822). Content-processing system 818 can include instructions for writing the first logical block address to a journal in a spare page of the block, wherein the journal indicates logical block addresses in an order corresponding to physical block addresses of data written to the block (LBA journal-writing module 826). Content-processing system 818 can also include instructions for rebuilding the mapping table (mapping table-reconstructing module 828) by: reading the journal to obtain the logical block addresses (data-reading module 832); and determining, based on the order, the physical block addresses corresponding to the obtained logical block addresses (mapping table-reconstructing module 828).

Content-processing system 818 can additionally include instructions for writing the logical block addresses in the journal (LBA journal-writing module 826) responsive to determining that a buffer storing the logical block addresses stores an amount of data sufficient to fill the spare page of the block (DRAM-managing module 824). Content-processing system 818 can include instructions for writing the first logical block address to the journal in the spare page of the block in parallel with the first data and the first logical block address being written to the block (data-writing module 830 and LBA journal-writing module 826). Content-processing system 818 can also include instructions for interleaving the write of the data and the write of the logical block addresses in the journal (data-writing module 830 and LBA journal-writing module 826).

Content-processing system 818 can further include instructions for reading journals from each of a plurality of blocks of the non-volatile memory to obtain a consolidated list of LBAs, wherein a respective journal indicates logical block addresses (LBAs) ordered corresponding to physical block addresses (PBAs) of data written to a respective block (data-reading module 832). Content-processing system 818 can include instructions for identifying, from the consolidated list for each unique logical block address, a most recent logical block address (LBA) and the corresponding physical block address (PBA) to obtain unique LBA-PBA pairs (mapping table-reconstructing module 828). Content-processing system 818 can include instructions for sorting the unique LBA-PBA pairs in an ascending order based on the LBA to obtain the mapping table (mapping table-reconstructing module 828).

Data 834 can include any data that is required as input or generated as output by the methods and/or processes described in this disclosure. Specifically, data 834 can store at least: data; a request; a read request; a write request; an input/output (I/O) request; data or metadata associated with a read request, a write request, or an I/O request; a physical block address (PBA); a logical block address (LBA); a mapping table; an entry which maps an LBA to a PBA; a journal; an LBA journal; a group, set, or plurality of LBAs; an indicator or identifier of a spare page(s) in a NAND block; a list of LBAs; an order corresponding to PBAs of data written to a block; an indicator or identifier of data, a page, a block, or a super block; an indicator of whether a block or a super block is open, closed, sealed, or in any other status; an interleaving of writing data and writing LBAs to the journal; a condition; a condition which triggers rebuilding of a mapping table; a most recent LBA corresponding to data along with a corresponding PBA; a unique LBA-PBA pair; a sorted list of unique LBA-PBA pairs; an ascending order; an indicator of a flash translation layer module; and an assigned PBA corresponding to an LBA.

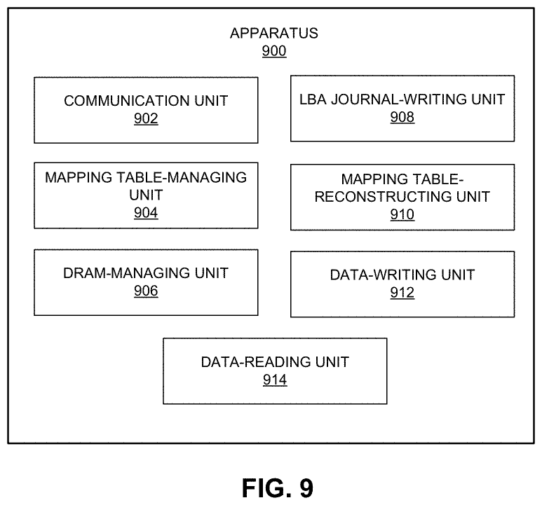

FIG. 9 illustrates an exemplary apparatus that facilitates reconstruction of a mapping table, in accordance with an embodiment of the present application. Apparatus 900 can comprise a plurality of units or apparatuses which may communicate with one another via a wired, wireless, quantum light, or electrical communication channel. Apparatus 900 may be realized using one or more integrated circuits, and may include fewer or more units or apparatuses than those shown in FIG. 9. Furthermore, apparatus 900 may be integrated in a computer system, or realized as a separate device or devices capable of communicating with other computer systems and/or devices.

Apparatus 900 can comprise modules or units 902-914 which are configured to perform functions or operations similar to modules 820-832 of computer system 800 of FIG. 8, including: a communication unit 902; a mapping table-managing unit 904; a DRAM-managing unit 906; an LBA journal-writing unit 908; a mapping table-reconstructing unit 910; a data-writing unit 912; and a data-reading unit 914.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A computer-implemented method, comprising:
writing, at a first physical block address, first data and a corresponding first logical block address to a block of a non-volatile memory;
storing, in a mapping table, an entry which maps the first logical block address to the first physical block address; and
writing the first logical block address to a journal in a spare page of the block, wherein the journal indicates logical block addresses in an order corresponding to physical block addresses of data written to the block.

2. The method of claim 1, further comprising:
receiving requests to write the first data and other data to the non-volatile memory, wherein the requests indicate the logical block addresses;
writing, at a respective physical block address, respective data and a respective logical block address to the block of the non-volatile memory; and
writing the logical block addresses to the journal in the spare page or another spare page of the block.

3. The method of claim 2,
wherein writing the logical block addresses in the journal is responsive to determining that a buffer storing the logical block addresses stores an amount of data sufficient to fill the spare page of the block.

4. The method of claim 2,
wherein the first logical block address is written to the journal in the spare page of the block in parallel with the first data and the first logical block address being written to the block.

5. The method of claim 2, further comprising:
interleaving the write of the data and the write of the logical block addresses in the journal,
wherein the first logical block address is written to the journal in the spare page of the block subsequent to the first data and the first logical block address and at least the respective data and the respective logical block address being written to the block.

6. The method of claim 1, further comprising:
detecting a condition which triggers rebuilding of the mapping table; and
rebuilding the mapping table by:
reading the journal to obtain the logical block addresses; and
determining, based on the order, the physical block addresses corresponding to the obtained logical block addresses.

7. The method of claim 6, wherein rebuilding the mapping table further comprises:
reading journals from each of a plurality of blocks of the non-volatile memory to obtain a consolidated list of LBAs,
wherein a respective journal indicates logical block addresses (LBAs) ordered corresponding to physical block addresses (PBAs) of data written to a respective block;
identifying, from the consolidated list for each unique logical block address, a most recent logical block address (LBA) and the corresponding physical block address (PBA) to obtain unique LBA-PBA pairs; and
sorting the unique LBA-PBA pairs in an ascending order based on the LBA to obtain the mapping table.

8. The method of claim 7,
wherein the mapping table is used by a flash translation layer module to perform subsequent read and write operations associated with the non-volatile memory.

9. The method of claim 1,
wherein the first physical block address is assigned by a flash translation layer module.

10. A computer system, comprising:
a processor; and
a memory coupled to the processor and storing instructions which, when executed by the processor, cause the processor to perform a method, the method comprising:
writing, at a first physical block address, first data and a corresponding first logical block address to a block of a non-volatile memory;
storing, in a mapping table, an entry which maps the first logical block address to the first physical block address; and
writing the first logical block address to a journal in a spare page of the block, wherein the journal indicates logical block addresses in an order corresponding to physical block addresses of data written to the block.

11. The computer system of claim 10, wherein the method further comprises:
receiving requests to write the first data and other data to the non-volatile memory, wherein the requests indicate the logical block addresses;
writing, at a respective physical block address, respective data and a respective logical block address to the block of the non-volatile memory; and
writing the logical block addresses to the journal in the spare page or another spare page of the block.

12. The computer system of claim 11,
wherein writing the logical block addresses in the journal is responsive to determining that a buffer storing the logical block addresses stores an amount of data sufficient to fill the spare page of the block.

13. The computer system of claim 11,
wherein the first logical block address is written to the journal in the spare page of the block in parallel with the first data and the first logical block address being written to the block.

14. The computer system of claim 11, wherein the method further comprises:
interleaving the write of the data and the write of the logical block addresses in the journal,
wherein the first logical block address is written to the journal in the spare page of the block subsequent to the first data and the first logical block address and at least the respective data and the respective logical block address being written to the block.

15. The computer system of claim 10, wherein the method further comprises:
detecting a condition which triggers rebuilding of the mapping table; and
rebuilding the mapping table by:
reading the journal to obtain the logical block addresses; and
determining, based on the order, the physical block addresses corresponding to the obtained logical block addresses.

16. The computer system of claim 15, wherein rebuilding the mapping table further comprises:
reading journals from each of a plurality of blocks of the non-volatile memory to obtain a consolidated list of LBAs,
wherein a respective journal indicates logical block addresses (LBAs) ordered corresponding to physical block addresses (PBAs) of data written to a respective block;
identifying, from the consolidated list for each unique logical block address, a most recent logical block address (LBA) and the corresponding physical block address (PBA) to obtain unique LBA-PBA pairs; and
sorting the unique LBA-PBA pairs in an ascending order based on the LBA to obtain the mapping table.

17. The computer system of claim 16,
wherein the mapping table is used by a flash translation layer module to perform subsequent read and write operations associated with the non-volatile memory.

18. The computer system of claim 10,
wherein the first physical block address is assigned by a flash translation layer module.

19. An apparatus, comprising:
a data-writing unit configured to write, at a first physical block address, first data and a corresponding first logical block address to a block of a non-volatile memory;
a mapping table-managing unit configured to store, in a mapping table, an entry which maps the first logical block address to the first physical block address; and
an LBA journal-writing module configured to write the first logical block address to a journal in a spare page of the block, wherein the journal indicates logical block addresses in an order corresponding to physical block addresses of data written to the block.

20. The apparatus of claim 19, further comprising:
a communication unit configured to receive requests to write the first data and other data to the non-volatile memory, wherein the requests indicate the logical block addresses;
wherein the data-writing unit is further configured to write, at a respective physical block address, respective data and a respective logical block address to the block of the non-volatile memory;
wherein the LBA journal-writing module is further configured to write the logical block addresses to the journal in the spare page or another spare page of the block; and
wherein the data-writing unit is further configured to interleave the write of the data and the write of the logical block addresses in the journal, wherein the first logical block address is written to the journal in the spare page of the block subsequent to the first data and the first logical block address and at least the respective data and the respective logical block address being written to the block; and
a mapping table-reconstructing unit configured to rebuild the mapping table by:
reading the journal to obtain the logical block addresses; and
determining, based on the order, the physical block addresses corresponding to the obtained logical block addresses.
